(19) United States
(12) Patent Application Publication
(10) Pub. No.: US 2018/0330057 A1
(43) Pub. Date: Nov. 15, 2018

(54) GENOME-WIDE ASSOCIATION STUDY METHOD FOR IMBALANCED SAMPLES

(71) Applicant: Tsinghua University, Beijing (CN)

(72) Inventors: Qionghai Dai, Beijing (CN); Feng Bao, Beijing (CN); Jinli Suo, Beijing (CN)

(21) Appl. No.: 15/830,165

(22) Filed: Dec. 4, 2017

(30) Foreign Application Priority Data
May 12, 2017 (CN) 201710334884.8

(51) Int. Cl. G06F 19/24; G06F 19/12

(52) U.S. Cl. CPC G06F 19/24; G06F 19/12

(57) ABSTRACT

The present disclosure provides a genome-wide association study method for imbalanced samples, including: randomly selecting L subsets from the healthy samples; pairing each of the L subsets with the diseased samples to obtain L sample combinations, and determining key genetic loci corresponding to each sample combination; evaluating a score of an importance degree of each sample combination according to times that each key genetic locus is determined in the L sample combinations; for each healthy sample, determining a mean value of scores of an importance degree of sample combinations that the healthy sample is assigned to, and determining the mean value as a confidence score of the healthy sample; and normalizing the confidence score of each healthy sample to obtain a weight of each healthy sample, and performing weighted logistic regression according to the weight of each healthy sample.

### CROSS-REFERENCE TO RELATED APPLICATION

This application is based upon and claims a priority to Chinese Patent Application Serial No. 201710334884.8, filed with the State Intellectual Property Office of P. R. China on May 12, 2017, the entire contents of which are incorporated herein by reference.

### FIELD

The present disclosure relates to a computational biology technology field, and more particularly to a genome-wide association study method for imbalanced samples.

### BACKGROUND

An important problem existing in genome-wide association study (GWAS for short) is that methods in the related art lack sufficient statistical ability to find all pathogenic factors when analyzing complex genetic diseases, causing that a lot of potential factors cannot be found, thus influencing analysis and diagnosis of causes of the diseases. The reason for this problem is various, in which a factor easy to overlook is to analyze a difference between the number of healthy samples and the number of diseased samples in data. Specifically, in GWAS analysis, a sample of diseased individuals is difficult to collect because a collection may be performed on individuals having a designated disease, people with gastric cancer for example, and correspondingly, a collection can be optionally performed on healthy people to obtain healthy samples. When performing GWAS analysis on rare diseases, it is particularly difficult to collect diseased samples, causing that diseased individual data account for only a small part in data to be analyzed.

In traditional GWAS analysis, logistic regression (LR for short) and χ² statistical test are usually used for analyzing relationship between each genetic locus and a phenotype. LR is widely used because LR can take factors of other covariates (such as age, gender, smoking or not, and the like) into account. However, when imbalance data is processed with LR, regression result was slanted to a category with the high sample number because the imbalance relationship between the number of healthy samples and the number of diseased samples in data, thus such that strength of associated information hidden in the gene sequence is underestimated, thus reducing the ability to discover the associated information hidden in the gene sequence.

### SUMMARY

Embodiments of the present disclosure provide a genome-wide association study method for imbalanced samples, in which the imbalanced samples include healthy samples and diseased samples, and the method includes: randomly selecting L subsets from the healthy samples, wherein a sample size of each of the L subsets is same as a sample size of the diseased samples; pairing each of the L subsets with the diseased samples to obtain L sample combinations, and determining key genetic loci corresponding to each sample combination; evaluating a score of an importance degree of each sample combination according to times that each key genetic locus is determined in the L sample combinations; for each healthy sample, determining a mean value of scores of an importance degree of sample combinations that the healthy sample is assigned to, and determining the mean value as a confidence score of the healthy sample; and normalizing the confidence score of each healthy sample to obtain a weight of each healthy sample, and performing weighted logistic regression according to the weight of each healthy sample, so as to test statistical significance of each of the key genetic loci.

Embodiments of the present disclosure provide a genome-wide association study device for imbalanced samples. The imbalanced samples include healthy samples and diseased samples, and the device includes a processor; and a memory for storing instructions executable by the processor. The processor is configured to perform the above genome-wide association study method for imbalanced samples.

Embodiments of the present disclosure provide a non-transitory computer-readable storage medium having stored therein instructions that, when executed by a processor of a terminal, causes the terminal to perform the above genome-wide association study method for imbalanced samples.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a genome-wide association study method for imbalanced samples according to an embodiment of the present disclosure;

FIG. 2 is a schematic diagram showing a detail process of a genome-wide association study method for imbalanced samples according to an embodiment of the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

The genome-wide association study method for imbalanced samples according to embodiments of the present disclosure will be described with reference to the drawings.

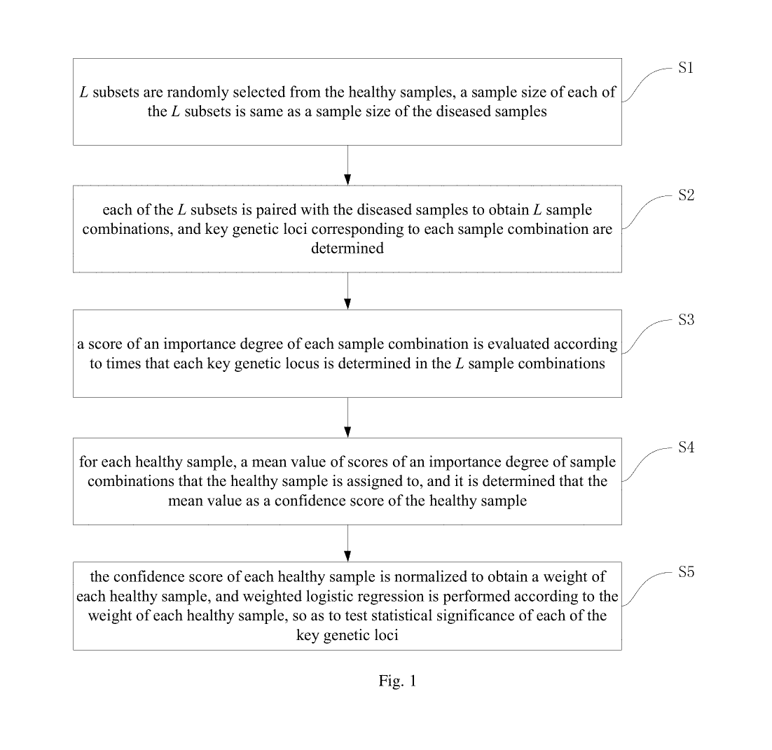

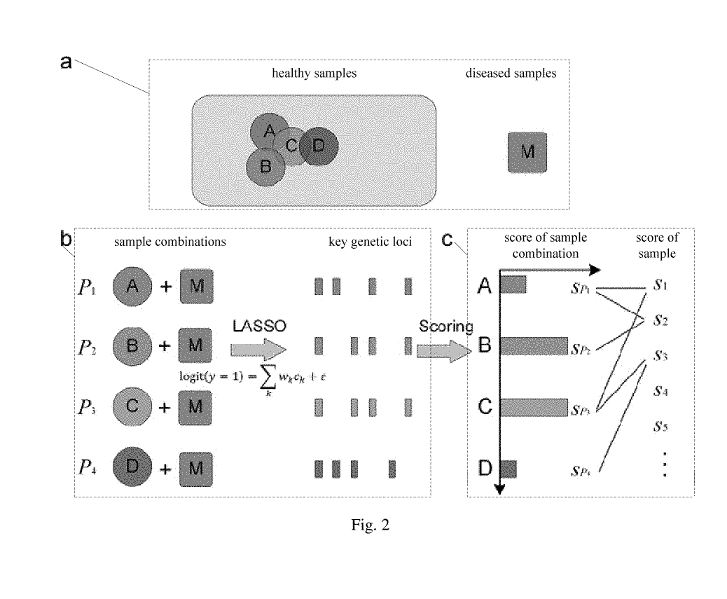

FIG. 1 is a flow chart of a genome-wide association study method for imbalanced samples according to an embodiment of the present disclosure. FIG. 2 is a schematic diagram showing a detail process of a genome-wide association study method for imbalanced samples according to an embodiment of the present disclosure. The imbalanced samples include healthy samples and diseased samples. In FIG. 2, part a shows an example of the imbalanced samples and a way of dividing the subsets of the healthy samples, part b shows composition of each sample combination and a process for analyzing the sample combinations and determining key genetic loci by Least Absolute Shrinkage and Selection Operator (LASSO for short), and part c shows a process of calculating a score of an importance degree of each sample combination according to the key genetic loci and calculating a score of an importance degree corresponding to each healthy sample according to the score of an importance degree of each sample combination.

As shown in FIG. 1 in combination with FIG. 2, the method include following acts.

In block S1, L subsets are randomly selected from the healthy samples.

A sample size of each of the L subsets is same as a sample size of the diseased samples.

In some embodiments, there is at least one healthy sample that is assigned to at least two subsets.

In block S2, each of the L subsets is paired with the diseased samples to obtain L sample combinations, and key genetic loci corresponding to each sample combination are determined.

That is, each of L subsets is paired with the diseased samples to form a new sample combination to be analyzed. For example, as shown in FIG. 2, four sample combinations denoted as (P₁, . . . , P₄) are formed according to four subsets selected in block S1 (denoted as A, B, C, D respectively) and the diseased samples M. Further, key genetic loci (i.e. essential genetic loci) corresponding to each sample combination are determined using a sparse optimization method (LASSO for example).

In an embodiment of the present disclosure, a process of determining the key genetic loci corresponding to each sample combination includes followings. Firstly, a linear regression model between genetic loci and phenotypes are established for each sample combination according to a formula of:

$$logit ( y = 1 ) = {\sum }_{i} {α}_{i} {c}_{i} + ɛ ,$$

where, cᵢ is a genotype of i^{th} genetic locus of each sample combination, y is a phenotype of each sample combination, αᵢ is a weight of the i^{th} genetic locus, and ϵ is an error. The logit function is the inverse of the sigmoidal “logistic” function or logistic transform used in mathematics, especially in statistics.

In this linear regression model, it is assumed that effect of each genetic locus on the phenotype is linear. Equation of the linear regression model is undetermined because each individual (i.e. each sample) has a lot of genetic loci. Therefore, LASSO is used for performing the sparse solution on the linear regression model to obtain the weight of each of the genetic loci. And then genetic loci having top T weights are selected as the key genetic loci for each sample combination.

In block S3, a score of an importance degree of each sample combination is evaluated according to times that each key genetic locus is determined in the L sample combinations.

In an embodiment of the present disclosure, block S3 may include followings.

In block S31, a frequency that each key genetic locus is determined from all the L sample combinations is calculated according to a following formula of:

$${f}_{{c}_{t}^{( l )}} = {\sum }_{i = 1}^{L} I ( {c}_{t}^{( l )} ∈ {P}_{i} ) / L ,$$

where, cₜ^{(l)} is t^{th} key genetic locus determined l^{th} sample combination, Pᵢ is the i^{th} sample combination, L is the number of the L sample combinations,

$${\sum }_{i = 1}^{L} I ( {c}_{t}^{( l )} ∈ {P}_{i} )$$

represents times that cₜ^{(l)} is determined in Pᵢ, f_{c}_{ₜ}₍ₗ₎ is a frequency that cₜ^{(l)} is determined from all the L sample combinations.

In block S32, the score of an importance degree of each sample combination is calculated according to times that each key genetic locus is determined in the L sample combinations using a following formula of:

$${s}_{{P}_{l}} = {\sum }_{t = 1}^{T} {f}_{{c}_{t}^{( l )}} / T ,$$

where, s_{P}_{ₗ} is a score of an importance degree of l^{th} sample combination, f_{c}_{ₜ}₍ₗ₎ is the frequency that cₜ^{(l)} is determined from all the L sample combinations, T is the number of key genetic loci determined in the l^{th} sample combination.

In block S4, for each healthy sample, a mean value of scores of an importance degree of sample combinations that the healthy sample is assigned to, and it is determined that the mean value as a confidence score of the healthy sample.

There may be at least one healthy sample that is assigned to at least two subsets. Therefore, the mean value can be determined as a confidence score of the healthy sample.

In block S5, the confidence score of each healthy sample is normalized to obtain a weight of each healthy sample, and weighted logistic regression is performed according to the weight of each healthy sample, so as to test statistical significance of each of the key genetic loci.

In an embodiment of the present disclosure, block S5 may include followings.

It assumed that there are K healthy samples and k diseased samples in the imbalanced samples, and the confidence score of each healthy sample is denoted as sᵢ (i=1, 2, . . . , K), then a weight of each healthy sample is obtained according to the confidence score of each healthy sample using a following formula of:

$${w}_{i} = {s}_{i} / {\sum }_{j = 1}^{K} {s}_{j} ,$$

where, K is the number of the healthy samples, wᵢ is the normalized score of i^{th} healthy sample, sᵢ is the confidence score of the i^{th} healthy sample, i=1, 2, . . . , K.

For the diseased samples, a weight of each diseased sample is determined according to following formula:

wᵢ=1/k,

where, k is the number of the diseased samples, wᵢ is a weight of i^{th} diseased sample, i=1, 2, . . . , k.

Then, the weighted logistic regression is defined as following regression equation:

$${L}_{w} ( θ ) = - {\sum }_{i = 1}^{K + k} {w}_{i} ln ( 1 + {e}^{( 1 - 2 {y}_{i} ) {X}_{i}^{T} θ} ) ,$$

where, θ is a weight to be estimate, K is the number of the healthy samples, k is the number of the diseased samples, wᵢ is a weight of i^{th} sample, yᵢ is a health state (or phenotype) of i^{th} sample (where, yᵢ=1 represents a diseased state, and yᵢ=0 represents a healthy state), Xᵢ^{T} is a covariate of the regression equation, such as gender, age or the like. An estimation result of parameters can be obtained by maximum likelihood estimation.

In an embodiment of the present disclosure, block S5 may further include that a statistical significance test is performed. A statistic of the statistical significance test is defined as:

LR=log L_{w}(θ)−log L_{w}(θ′|NULL)

where, LR is a likelihood ratio, log L_{w}(θ′|NULL) represents that the genetic locus is not considered and only a regression result of the covariate is considered. 2LR is subject to a chi-squared distribution, therefore P-value of the statistical significance test can be obtained by referring to this distribution.

In conclusion, with the method according to above embodiments of the present disclosure, based on improving study theory in the related art, different importance weights are given to samples with many types. At the same time, the method has a special design aim at a special structure of genetic data and particularity of GWAS problem. The whole method is base on a two-step learning frame of “preliminary screening-comprehensive analysis”. In the preliminary screening part, the method can obtain key genetic loci for different sub data sets using an optimized one-norm constraint LASSO method, and evaluates each sub data set according to consistent information of genetic characteristics extracted in different sub data sets. In comprehensive analysis part, evaluation result of each sample is integrated into the weighted logistic regression, and statistical test value of each genetic locus level is calculated.

With the genome-wide association study method for imbalanced samples, by selecting a plurality of balanced sample subsets and finding out the key genetic loci, and calculating the weight of importance degree of each healthy sample, and finally statistically evaluating influence of genetic loci on disease in combination with the weighted logistic regression, capacity for analyzing imbalanced samples is significantly improved.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A genome-wide association study method for imbalanced samples, wherein the imbalanced samples comprise healthy samples and diseased samples, the method comprises:
randomly selecting L subsets from the healthy samples, wherein a sample size of each of the L subsets is same as a sample size of the diseased samples;
pairing each of the L subsets with the diseased samples to obtain L sample combinations, and determining key genetic loci corresponding to each sample combination;
evaluating a score of an importance degree of each sample combination according to times that each key genetic locus is determined in the L sample combinations;
for each healthy sample, determining a mean value of scores of an importance degree of sample combinations that the healthy sample is assigned to, and determining the mean value as a confidence score of the healthy sample; and
normalizing the confidence score of each healthy sample to obtain a weight of each healthy sample, and performing weighted logistic regression according to the weight of each healthy sample, so as to test statistical significance of each of the key genetic loci.

2. The method according to claim 1, wherein determining key genetic loci corresponding to each sample combination comprises:
establishing a linear regression model between genetic loci and phenotypes for each sample combination according to a following formula of
$$logit ( y = 1 ) = {\sum }_{i} {α}_{i} {c}_{i} + ɛ ,$$
where, cᵢ is a genotype of i^{th} genetic locus of each sample combination, y is a phenotype of each sample combination, αᵢ is a weight of the i^{th} genetic locus, and ϵ is an error;
performing a sparse solution on the linear regression model using a method of Least Absolute Shrinkage and Selection Operator to obtain the weight of each of the genetic loci; and
selecting genetic loci having top T weights as the key genetic loci for each sample combination.

3. The method according to claim 2, wherein evaluating a score of an importance degree of each sample combination according to times that each key genetic locus is determined in the L sample combinations comprises:
calculating a frequency that each key genetic locus is determined from all the L sample combinations according to a following formula of:
$${f}_{{c}_{t}^{( l )}} = {\sum }_{i = 1}^{L} I ( {c}_{t}^{( l )} ∈ {P}_{i} ) / L ,$$
where, cₜ^{(l)} is i^{th} key genetic locus determined l^{th} sample combination, Pᵢ is the i^{th} sample combination, L is the number of the L sample combinations,
$${\sum }_{i = 1}^{L} I ( {c}_{t}^{( l )} ∈ {P}_{i} )$$
represents times that cₜ^{(l)} is determined in Pᵢ,
$${f}_{{c}_{t}^{( l )}}$$
is a frequency that cₜ^{(l)} is determined from all the L sample combinations; and
calculating the score of an importance degree of each sample combination according to times that each key genetic locus is determined in the L sample combinations using a following formula of:
$${s}_{{P}_{l}} = {\sum }_{t = 1}^{T} {f}_{{c}_{t}^{( l )}} / T ,$$
where, s_{P}_{ₗ} is a score of an importance degree of l^{th} sample combination, T is the number of key genetic loci determined in the l^{th} sample combination.

4. The method according to claim 1, wherein normalizing the confidence score of each healthy sample to obtain a weight of each healthy sample, and performing weighted logistic regression according to the weight of each healthy sample, so as to test statistical significance of each of the key genetic loci comprises:
obtaining a weight of each healthy sample according to the confidence score of each healthy sample using a following formula of:
$${w}_{i} = {s}_{i} / {\sum }_{j = 1}^{K} {s}_{j} ,$$
where, K is the number of the healthy samples, wᵢ is the normalized score of i^{th} healthy sample, sᵢ is the confidence score of the i^{th} healthy sample, i=1, 2, . . . , K;
determining a weight of each diseased sample according to a following formula of:
wᵢ=1/k,
where, k is the number of the diseased samples, wᵢ is a weight of i^{th} diseased sample, i=1, 2, . . . , k; and
performing the weighted logistic regression according to a following regression equation of:
$${L}_{w} ( θ ) = - {\sum }_{i = 1}^{K + k} {w}_{i} ln ( 1 + {e}^{( 1 - 2 {y}_{i} ) {X}_{i}^{T} θ} ) ,$$
where, θ is a weight to be estimated, wᵢ is a weight of i^{th} sample, yᵢ is a health state of i^{th} sample combination, and Xᵢ^{T} is a covariate of the regression equation.

5. The method according to claim 4, wherein normalizing the confidence score of each healthy sample to obtain a weight of each healthy sample, and performing weighted logistic regression according to the weight of each healthy sample, so as to test statistical significance of each of the key genetic loci further comprises:
performing a statistical significance test, wherein a statistic of the statistical significance test is defined as:
LR=log L_{w}(θ)−log L_{w}(θ′|NULL)
where, LR is a likelihood ratio, log L_{w} (θ′|NULL) represents that the genetic locus is not considered and only a regression result of the covariate is considered.

6. The method according to claim 1, wherein there is at least one healthy sample that is assigned to at least two subsets.

7. A genome-wide association study device for imbalanced samples, wherein the imbalanced samples comprise healthy samples and diseased samples, and the device comprises:
a processor; and
a memory for storing instructions executable by the processor,
wherein the processor is configured to:
randomly select L subsets from the healthy samples, wherein a sample size of each of the L subsets is same as a sample size of the diseased samples;
pair each of the L subsets with the diseased samples to obtain L sample combinations, and determine key genetic loci corresponding to each sample combination;
evaluate a score of an importance degree of each sample combination according to times that each key genetic locus is determined in the L sample combinations;
for each healthy sample, determine a mean value of scores of an importance degree of sample combinations that the healthy sample is assigned to, and determine the mean value as a confidence score of the healthy sample; and
normalize the confidence score of each healthy sample to obtain a weight of each healthy sample, and perform weighted logistic regression according to the weight of each healthy sample, so as to test statistical significance of each of the key genetic loci.

8. The device according to claim 7, where the processor is configured to determine key genetic loci corresponding to each sample combination by acts of:
establishing a linear regression model between genetic loci and phenotypes for each sample combination according to a following formula of:
$$logit ( y = 1 ) = {\sum }_{i} {α}_{i} {c}_{i} + ɛ ,$$
where, cᵢ is a genotype of i^{th} genetic locus of each sample combination, y is a phenotype of each sample combination, αᵢ is a weight of the i^{th} genetic locus, and ϵ is an error;
performing a sparse solution on the linear regression model using a method of Least Absolute Shrinkage and Selection Operator to obtain the weight of each of the genetic loci; and
selecting genetic loci having top T weights as the key genetic loci for each sample combination.

9. The device according to claim 8, wherein the processor is configured to evaluate a score of an importance degree of each sample combination according to times that each key genetic locus is determined in the L sample combinations by acts of:
calculating a frequency that each key genetic locus is determined from all the L sample combinations according to a following formula of:
$${f}_{{c}_{t}^{( l )}} = {\sum }_{i = 1}^{L} I ( {c}_{t}^{( l )} ∈ {P}_{i} ) / L ,$$
where, cₜ^{(l)} is t^{th} key genetic locus determined in l^{th} sample combination, Pᵢ is the i^{th} sample combination, L is the number of the L sample combinations,
$${\sum }_{i = 1}^{L} I ( {c}_{t}^{( l )} ∈ {P}_{i} )$$
represents times that cₜ^{(l)} is determined in Pᵢ,
$${f}_{{c}_{t}^{( l )}}$$
is a frequency that cₜ^{(l)} is determined from all the L sample combinations; and
calculating the score of an importance degree of each sample combination according to times that each key genetic locus is determined in the L sample combinations using a following formula of:
$${s}_{{P}_{l}} = {\sum }_{t = 1}^{T} {f}_{{c}_{t}^{( l )}} / T ,$$
where, s_{P}_{ₗ} is a score of an importance degree of l^{th} sample combination, T is the number of key genetic loci determined in the l^{th} sample combination.

10. The device according to claim 9, wherein the processor is configured to normalize the confidence score of each healthy sample to obtain a weight of each healthy sample, and perform weighted logistic regression according to the weight of each healthy sample, so as to test statistical significance of each of the key genetic loci by acts of:
obtaining a weight of each healthy sample according to the confidence score of each healthy sample using a following formula of:
$${w}_{i} = {s}_{i} / {\sum }_{j = 1}^{K} {s}_{j} ,$$
where, K is the number of the healthy samples, wᵢ is the normalized score of i^{th} healthy sample, sᵢ is the confidence score of the i^{th} healthy sample, i=1, 2, . . . , K;
determining a weight of each diseased sample according to a following formula of:
wᵢ=1/k,
where, k is the number of the diseased samples, wᵢ is a weight of i^{th} diseased sample, i=1, 2, . . . , k; and
performing the weighted logistic regression according to a following regression equation of:
$${L}_{w} ( θ ) = - {\sum }_{i = 1}^{K + k} {w}_{i} ln ( 1 + {e}^{( 1 - 2 {y}_{i} ) {X}_{i}^{T} θ} ) ,$$
where, θ is a weight to be estimated, wᵢ is a weight of i^{th} sample, yᵢ is a health state of i^{th} sample combination, and Xᵢ^{T} is a covariate of the regression equation.

11. The device according to claim 10, wherein the processor is configured to normalize the confidence score of each healthy sample to obtain a weight of each healthy sample, and perform weighted logistic regression according to the weight of each healthy sample, so as to test statistical significance of each of the key genetic loci by further acts of:
performing a statistical significance test, wherein a statistic of the statistical significance test is defined as:
LR=log L_{w}(θ)−log L_{w}(θ′|NULL)
where, LR is a likelihood ratio, log L_{w} (θ′|NULL) represents that the genetic locus is not considered and only a regression result of the covariate is considered.

12. The device according to claim 7, wherein there is at least one healthy sample that is assigned to at least two subsets.

13. A non-transitory computer-readable storage medium having stored therein instructions that, when executed by a processor of a terminal, causes the terminal to perform a genome-wide association study method for imbalanced samples, wherein the imbalanced samples comprise healthy samples and diseased samples, and the method comprises:
randomly selecting L subsets from the healthy samples, wherein a sample size of each of the L subsets is same as a sample size of the diseased samples;
pairing each of the L subsets with the diseased samples to obtain L sample combinations, and determining key genetic loci corresponding to each sample combination;
evaluating a score of an importance degree of each sample combination according to times that each key genetic locus is determined in the L sample combinations;
for each healthy sample, determining a mean value of scores of an importance degree of sample combinations that the healthy sample is assigned to, and determining the mean value as a confidence score of the healthy sample; and
normalizing the confidence score of each healthy sample to obtain a weight of each healthy sample, and performing weighted logistic regression according to the weight of each healthy sample, so as to test statistical significance of each of the key genetic loci.

14. The non-transitory computer-readable storage medium according to claim 13, wherein determining key genetic loci corresponding to each sample combination comprises:
establishing a linear regression model between genetic loci and phenotypes for each sample combination according to a following formula of:
$$logit ( y = 1 ) = {\sum }_{i} {α}_{i} {c}_{i} + ɛ ,$$
where, cᵢ is a genotype of i^{th} genetic locus of each sample combination, y is a phenotype of each sample combination, αᵢ is a weight of the i^{th} genetic locus, and ϵ is an error;
performing a sparse solution on the linear regression model using a method of Least Absolute Shrinkage and Selection Operator to obtain the weight of each of the genetic loci; and
selecting genetic loci having top T weights as the key genetic loci for each sample combination.

15. The non-transitory computer-readable storage medium according to claim 14, wherein evaluating a score of an importance degree of each sample combination according to times that each key genetic locus is determined in the L sample combinations comprises:
calculating a frequency that each key genetic locus is determined from all the L sample combinations according to a following formula of:
$${f}_{{c}_{t}^{( l )}} = {\sum }_{i = 1}^{L} I ( {c}_{t}^{( l )} ∈ {P}_{i} ) / L ,$$
where, cₜ^{(l)} is t^{th} key genetic locus determined in l^{th} sample combination, Pᵢ is the i^{th} sample combination, L is the number of the L sample combinations,
$${\sum }_{i = 1}^{L} I ( {c}_{t}^{( l )} ∈ {P}_{i} )$$
represents times that cₜ^{(l)} is determined in Pᵢ,
$${f}_{{c}_{t}^{( l )}}$$
is a frequency that cₜ^{(l)} is determined from all the L sample combinations; and
calculating the score of an importance degree of each sample combination according to times that each key genetic locus is determined in the L sample combinations using a following formula of:
$${s}_{{P}_{l}} = {\sum }_{t = 1}^{T} {f}_{{c}_{t}^{( l )}} / T ,$$
where, s_{P}_{ₗ} is a score of an importance degree of l^{th} sample combination, T is the number of key genetic loci determined in the l^{th} sample combination.

16. The non-transitory computer-readable storage medium according to claim 13, wherein normalizing the confidence score of each healthy sample to obtain a weight of each healthy sample, and performing weighted logistic regression according to the weight of each healthy sample, so as to test statistical significance of each of the key genetic loci comprises:
obtaining a weight of each healthy sample according to the confidence score of each healthy sample using a following formula of
$${w}_{i} = {s}_{i} / {\sum }_{j = 1}^{K} {s}_{j} ,$$
where, K is the number of the healthy samples, wᵢ is the normalized score of i^{th} healthy sample, sᵢ is the confidence score of the i^{th} healthy sample, i=1, 2, . . . , K;
determining a weight of each diseased sample according to a following formula of:
wᵢ=1/k,
where, k is the number of the diseased samples, wᵢ is a weight of i^{th} diseased sample, i==1, 2, . . . , k; and
performing the weighted logistic regression according to a following regression equation of:
$${L}_{w} ( θ ) = - {\sum }_{i = 1}^{K + k} {w}_{i} ln ( 1 + {e}^{( 1 - 2 {y}_{i} ) {X}_{i}^{T} θ} ) ,$$
where, θ is a weight to be estimated, wᵢ is a weight of i^{th} sample, yᵢ is a health state of i^{th} sample combination, and Xᵢ^{T} is a covariate of the regression equation.

17. The non-transitory computer-readable storage medium according to claim 16, wherein normalizing the confidence score of each healthy sample to obtain a weight of each healthy sample, and performing weighted logistic regression according to the weight of each healthy sample, so as to test statistical significance of each of the key genetic loci further comprises:
performing a statistical significance test, wherein a statistic of the statistical significance test is defined as:
LR=log L_{w}(θ)−log L_{w}(θ′|NULL)
where, LR is a likelihood ratio, log L_{w} (θ′|NULL) represents that the genetic locus is not considered and only a regression result of the covariate is considered.

18. The non-transitory computer-readable storage medium according to claim 13, wherein there is at least one healthy sample that is assigned to at least two subsets.
